(19) United States
(12) Patent Application Publication
(10) Pub. No.: US 2026/0060205 A1
(43) Pub. Date: Mar. 5, 2026

(54) PET FEEDER

(71) Applicant: Dongguan ZhiYiHong Hardware & Plastic Co., Ltd., Dongguan (CN)

(72) Inventor: Zhiqi Xue, Dongguan (CN)

(73) Assignee: Dongguan ZhiYiHong Hardware & Plastic Co., Ltd., Dongguan (CN)

(21) Appl. No.: 19/286,282

(22) Filed: Jul. 31, 2025

(30) Foreign Application Priority Data
Aug. 28, 2024 (CN) 202422095892.X
Aug. 28, 2024 (CN) 202422096295.9

(51) Int. Cl. A01K 5/01; A01K 5/02

(52) U.S. Cl. CPC A01K 5/0114; A01K 5/0225

(57) ABSTRACT

A pet feeder includes a main food tank, and a food conveyer including a food storage member and a driving assembly; the food conveyer has a food inlet communicating with the main food tank and a food outlet communicating with outside; the food storage member has an opening; pet foods in the main food tank enter the food storage member through the food inlet and the opening of the food storage member sequentially; when the driving assembly drives the food storage member to move from lower position to higher position, pet foods in the food storage member fall to outside through the food outlet. The driving assembly and food storage member carry pet foods in the main food tank from lower position to higher position and convey to outside through the food outlet for pets to eat, solving problem of low feeding position is inconvenient for pets to eat.

### FIELD OF THE INVENTION

The present application relates to the technical field of pet supplies, and specifically relates to a pet feeder.

### BACKGROUND OF THE INVENTION

Pet feeders provided by existing technology typically feed foods directly from the bottom of main food tanks, which are at a low position and easily leads to food accumulation and blockage. Moreover, pets need to keep heads at a lower angle when eating from such feeders, which is not friendly for larger pets. If the feeder is elevated, it would waste the space at the bottom of the feeder.

Therefore, it is necessary to propose a novel technical solution to solve the above technical issues.

### SUMMARY OF THE INVENTION

An objective of the present application is to provide a pet feeder to solve the problem of a feeding position being too low, making it inconvenient for pets to eat.

In order to solve the above problem, the technical solution to be solved by the present application is as follows.

The present application provides a pet feeder, comprising:
a main food tank provided with a cavity for accommodating pet foods; and
a food conveyer comprising a fixed frame fixedly connected to the main food tank, a food storage member for carrying the pet foods, and a driving assembly for driving the food storage member to move, the pet foods in the food storage member being carried from a lower position to a higher position by the driving assembly;
the food conveyer is provided with a food inlet communicating with the main food tank and a food outlet communicating with outside; the food storage member is provided with at least one opening; the pet foods in the main food tank enter the food storage member through the food inlet and the opening of the food storage member in sequence; and when the driving assembly drives the food storage member carrying the pet foods to move to the higher position, the pet foods in the food storage member fall to outside through the food outlet.

Preferably, the food storage member comprises a plurality of secondary food tanks which are spaced from one another and are arranged in sequence; and by the driving of the driving component, any secondary food tank passes through the food inlet and the food outlet in sequence, and the secondary food tank communicates with the food inlet or the food outlet respectively when passing through the food inlet and the food outlet.

Preferably, the food storage member is of a disc-shaped structure, and the plurality of secondary food tanks are arranged in a circumferential direction of the disc-shaped structure.

Preferably, the food storage member comprises two oppositely-arranged annular panels, and side plates connected to outer edges of the two annular panels, and further comprises a plurality of partition plates which are simultaneously connected and fixed with the two annular panels and the side plates; and any two adjacent partition plates, the annular panels and the side plates are enclosed together to form the secondary food tanks.

Preferably, the food conveyer further comprises an annular baffle which is embedded into an inner edge of the food storage member and is fixedly connected to the fixed frame; the food outlet is formed in the annular baffle; and the food outlet in a vertical direction is higher than the central axis of the annular baffle.

Preferably, the food outlet is formed in the highest position of the annular baffle in the vertical direction.

Preferably, the food inlet is formed in the annular baffle.

Preferably, the driving assembly comprises a motor and a transmission gear set; clamping teeth are arranged on the peripheries of the side plates, and the food storage member is in meshed connection with the transmission gear set through the clamping teeth on the side plates; and
the food storage member can be driven by the driving assembly to perform autorotation around own central axis.

Preferably, the driving assembly further comprises limiting members; the limiting members are provided with limiting grooves which are slightly wider than the clamping teeth; and the limiting grooves are arranged on the peripheries of the clamping teeth in a crossing mode.

Preferably, at least two limiting members are arranged, and a connecting line between the two limiting members passes through the central axis of the food storage member.

Preferably, each limiting member comprises a fixed shaft fixedly connected to the fixed frame, and a rolling guide wheel which sleeves the fixed shaft; the rolling guide wheel is provided with two limiting wheels which are oppositely arranged and abut against the corresponding side plate; and each limiting groove is formed between every two limiting wheels.

Preferably, the pet feeder further comprises food bowls used for receiving the pet foods falling from the food outlet, wherein the food bowls are lower than the food outlet and higher than the food inlet in the vertical direction.

Preferably, food bowls are arranged on the top of the main food tank.

Preferably, the food conveyer is arranged on the central axis of the main food tank and perpendicularly divides the main food tank equally; and two food bowls are provided and located on two sides of the food conveyer respectively.

Preferably, the driving assembly comprises a motor and a transmission shaft, and the transmission shaft is fixedly connected to a central axis of the food storage member; and when the motor is started, the transmission shaft drives the food storage member to perform autorotation around own central axis.

Preferably, the bottom of the cavity, used for accommodating the pet foods, of the main food tank is arranged to be an inclined plane.

Preferably, the food inlet in the vertical direction is lower than the lowest position of the inner inclined plane of the main food tank.

Preferably, the food conveyer further comprises a food guide plate, and the food guide plate is provided with food guide groove bodies matched with the food inlet and the food outlet respectively.

Preferably, each food guide groove body comprises two guide portions which are arranged oppositely, and a sliding portion connected between the two guide portions.

Preferably, the sliding portions are inclined planes.

In the present application, the driving assembly and food storage member carry pet foods in the main food tank from lower position to higher position and convey to outside through the food outlet for pets to eat, solving problem of low feeding position is inconvenient for pets to eat.

### BRIEF DESCRIPTION OF THE DRAWINGS

FIG. 1 is a schematic structural diagram (side view) of a pet feeder in an Embodiment 1 provided by the present application.

FIG. 2 is a sectional view of cutting in an A-A direction in FIG. 1 provided by the present application.

FIG. 3 is a schematic structural diagram (3D view) of a food conveyer of a pet feeder in an Embodiment 1 provided by the present application;

FIG. 4 is a local amplification diagram of a part D in FIG. 3.

FIG. 5 is a schematic structural diagram (front view) of a pet feeder in an Embodiment 1 provided by the present application;

FIG. 6 is a sectional view of cutting in a B-B direction in FIG. 5 provided by the present application;

FIG. 7 is a schematic structural diagram (side view) of a pet feeder in an Embodiment 2 provided by the present application;

FIG. 8 is a sectional view of cutting in one direction of a pet feeder in an Embodiment 2 provided by the present application;

FIG. 9 is a schematic structural diagram (3D view) of a pet feeder in an Embodiment 3 provided by the present application;

FIG. 10 is a sectional view of cutting in one direction of a pet feeder in an Embodiment 3 provided by the present application;

FIG. 11 is a sectional view of cutting in another direction of a pet feeder in an Embodiment 3 provided by the present application;

FIG. 12 is a schematic structural diagram (3D view) of a pet feeder in an Embodiment 4 provided by the present application;

FIG. 13 is a schematic structural diagram (exploded diagram) of a pet feeder in an Embodiment 4 provided by the present application; and

FIG. 14 is a sectional view of cutting in one direction of a pet feeder in an Embodiment 4 provided by the present application.

### DETAILED DESCRIPTION OF SOME EMBODIMENTS

In order to make the objectives, the technical solutions and the advantages of the embodiments of the present application more clear, the technical solutions in the embodiments of the present application will be illustrated clearly and completely hereinafter with reference to the accompanying drawings in the embodiments of the present application. Apparently, the embodiments described are merely some but not all of the embodiments of the present application. Based on the embodiments of the present application, all other embodiments obtained by those of ordinary skills in the art without going through any creative work should fall within the scope of protection of the present application.

The meanings of the terms used in this description and the claims correspond to the meanings understood by those of ordinary skill in the art related to the present application. The terms used in this description and the claims are only for the purpose of facilitating the narration and understanding of the present application, and are not intended to limit the present application to a narrow interpretation of the specific terms used in the description and the claims.

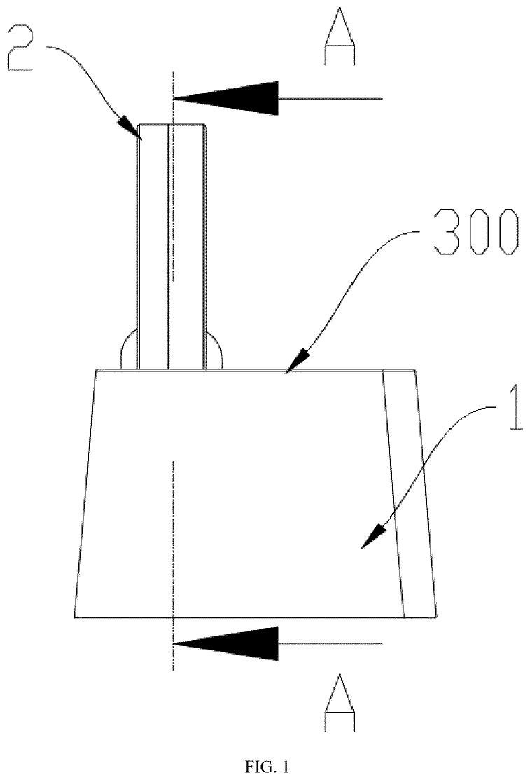

As shown in FIG. 1 to FIG. 6, an embodiment of the present application provides a pet feeder, which includes: a main food tank 1 and a food conveyer 2, and the main food tank 1 is provided with a cavity for accommodating pet foods; the food conveyer 2 includes a fixed frame 25 fixedly connected to the main food tank 1, a food storage member 21 for carrying the pet foods, and a driving assembly 22 for driving the food storage member 21 to move, and therefore, the pet foods in the food storage member 21 are carried from a lower position to a higher position by the driving assembly 22; the food conveyer 2 is provided with a food inlet 200 communicating with the main food tank 1 and a food outlet 400 communicating with outside; the food storage member 21 is provided with at least one opening; the pet foods in the main food tank 1 enter the food storage member 21 through the food inlet 200 and the opening of the food storage member 21 in sequence; the food storage member 21 can store the pet foods and carry the pet foods to move; and when the driving assembly 22 drives the food storage member 21 carrying the pet foods to move to the higher position, the pet foods in the food storage member 21 will fall to the outside of the pet feeder after passing through the opening of the food storage member 21 and the food outlet 400 in sequence.

On the basis of the pet feeder provided by the present application, food bowls for receiving the pet foods and feeding a pet can be placed at the food outlet 400, thus the effect that the food bowls are higher than the bottom of the main food tank 1 can be realized, and the problem of a feeding position being too low, making it inconvenient for the pet to eat is solved.

In order to help those skilled in the art better understand the solutions in the present application, the technical solutions in the embodiments of the present application will be described clearly and completely in conjunction with the accompanying drawings below.

### Embodiment 1

As shown in FIG. 1 to FIG. 6, which show an Embodiment 1 of a pet feeder provided by the present application; in this embodiment, the pet feeder includes: the main food tank 1 and the food conveyer 2, and the main food tank 1 is provided with the cavity for accommodating pet foods; the food conveyer 2 includes a fixed frame 25 fixedly connected to the main food tank 1, a food storage member 21 for carrying the pet foods, and a driving component 22 for driving the food storage member 21 to move, and therefore, the pet foods in the food storage member 21 are carried from the lower position to the higher position by the driving component 22.

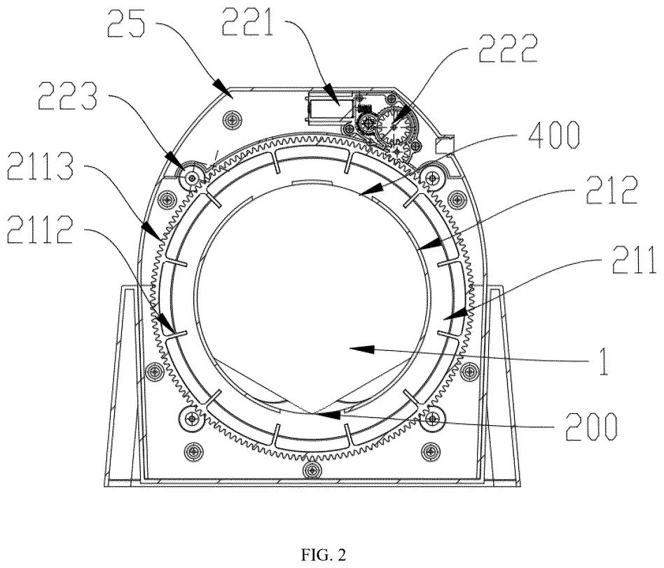

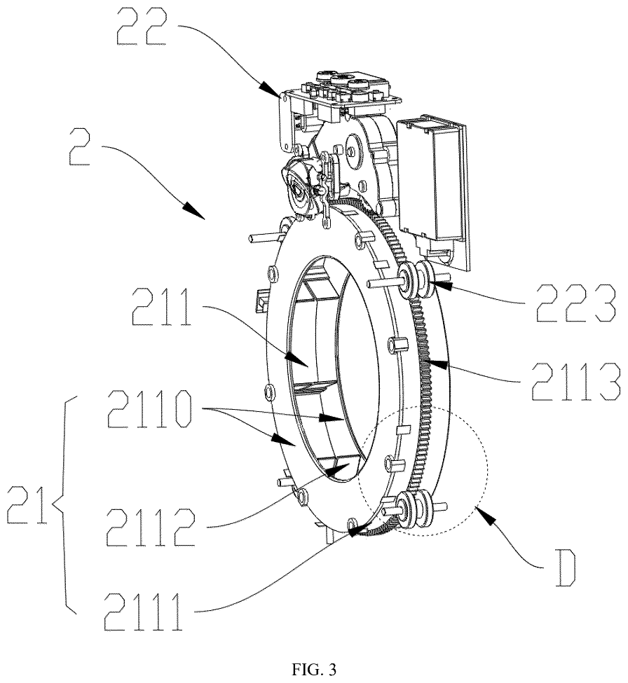

With reference to FIG. 2 to FIG. 3, the food conveyer 2 is provided with the food inlet 200 communicating with the main food tank 1 and the food outlet 400 communicating with the outside; the food storage member 21 is provided with at least one opening; the pet foods in the main food tank 1 enter the food storage member 21 through the food inlet 200 and the opening of the food storage member 21 in sequence; the food storage member 21 can store the pet foods and carry the pet foods to move; when the driving component 22 drives the food storage member 21 carrying the pet foods to move to the higher position, the pet foods in the food storage member 21 fall to the outside of the pet feeder after passing through the opening of the food storage member 21 and the food outlet 400 in sequence by gravity.

Preferably, the food storage member 21 includes a plurality of secondary food tanks 211 which are spaced from one another and are arranged in sequence; each secondary food tank 211 is provided with an opening for the pet foods to enter and a tank body structure for loading the pet foods. Exemplarily, any two secondary food tanks 211 have the same capacity.

By arranging the plurality of secondary food tanks 211 which are spaced from one another and have the same capacity, the amount of foods discharged from the main food tank 1 can be pre-distributed; and moreover, the plurality of secondary food tanks 211 independently store the pet foods, which effectively avoids mutual pollution of the foods in the food conveying process.

By the driving of the driving component 22, any secondary food tank 211 passes through the food inlet 200 and the food outlet 400 in sequence, and the opening of the secondary food tank 211 communicates with the food inlet 200 or the food outlet 400 when the secondary food tank 211 passes through the food inlet 200 and the food outlet 400.

On the basis of the above arrangement, when the driving assembly 22 drives the food storage member 21 to move, the openings of the plurality of secondary food tanks 211 can pass through the food inlet 200 respectively and communicate with the main food tank 1 through the food inlet 200, at the moment, the pet foods in the main food tank 1 will enter the secondary food tanks 211 through the food inlet 200 and the openings of the secondary food tanks 211; along with continuous movement of the food storage member 21, each secondary food tank 211 will communicate with the main food tank 1, thus each secondary food tank 211 carries a certain volume of pet foods after completely passing through the food inlet 200; and moreover, each secondary food tank 211 will convey the carried foods to the food outlet 400 along with movement of the driving assembly and finally the foods fall to the outside of the pet feeder through the food outlet 400.

By means of this arrangement, the movement parameters of the food storage member 21 under the control of the driving assembly 22 can be adjusted and controlled so as to control the food discharge volume of the food storage member 21, and finally the purpose of controlling the feeding amount of the pet feeder each time is achieved.

For example, the driving assembly 22 can be used for controlling the number of the secondary food tanks 211 passing through the food outlet 400 in the one-time movement process of the food storage member 21, and each secondary food tank 211 passes through the food outlet 400 once to achieve food feeding of one unit volume. Therefore, the feeding amount in unit time can be controlled only by controlling the number of the secondary food tanks 211 passing through the food outlet 400 in unit time.

With reference to FIG. 2 to FIG. 3, preferably, the food storage member 21 is of a disc-shaped structure, an axis in which a circle center of the disc-shaped structure is located is parallel to the horizontal plane, a disc surface of the disc-shaped structure is perpendicular to the horizontal plane, and the plurality of secondary food tanks 211 are arranged in a circumferential direction of the disc-shaped structure.

Optionally, the driving assembly 22 is configured to drive the food storage member 21 to perform autorotation along own central axis; and along with autorotation of the food storage member 21, the plurality of secondary food tanks 211 arranged in the circumferential direction of the food storage member 21 can rotate to the higher position from the lower position in sequence.

With reference to FIG. 3, preferably, the food storage member 21 includes two oppositely-arranged annular panels 2110, and side plates 2111 connected to outer edges of the two annular panels 2110, and further includes a plurality of partition plates 2112 which are simultaneously connected and fixed with the two annular panels 2110 and the side plates 2111; and any two adjacent partition plates 2112, the annular panels 2110 and the side plates 2111 are enclosed together to form the secondary food tanks 211. Exemplarily, the two annular panels 2110 have the same size.

With reference to FIG. 2 to FIG. 4, preferably, the food conveyer 2 further includes an annular baffle 212 which is embedded into an inner edge of the food storage member 21 and is fixedly connected to the fixed frame 25; the food outlet 400 is formed in the annular baffle 212; and the food outlet 400 in a vertical direction is higher than the central axis of the annular baffle 212.

With reference to FIG. 2 to FIG. 4, the annular baffle 212 is set to be of a cylindrical structure which extends along the central axis direction of the food storage member 21 and have openings in the two ends; the annular baffle 212 is located on the central inner edge of the annular panels 2110, and can be set to be pressed against the inner edges of the annular panels 2110. When the driving assembly 22 drives the food storage member 21 to move, the annular baffle 212 is fixed, the plurality of secondary food tanks 211 formed by the annular panels 2110, the side plates 2111 and the partition plates 2112 will revolve around the annular baffle 212, and the openings of the plurality of secondary food tanks 211 will be temporarily closed by the annular baffle 212 along with rotation, which makes the secondary food tanks 211 in a temporary closed state, thereby preventing the pet foods loaded in the secondary food tanks 211 from falling out in the process of moving the secondary food tanks 211 from the lower position to the higher position. When any secondary food tank 211 carrying the pet foods rotates to the food outlet 400, the opening of the secondary food tank 211 communicates with the food outlet 400, and the foods in the secondary food tanks 211 will fall off from the food outlet 400 by gravity.

Preferably, the food outlet 400 is formed in the highest position of the annular baffle 212 in the vertical direction. By means of this arrangement, the foods in the secondary food tanks 211 can vertically fall off, which is conducive to quickly feeding foods and avoiding food blockage.

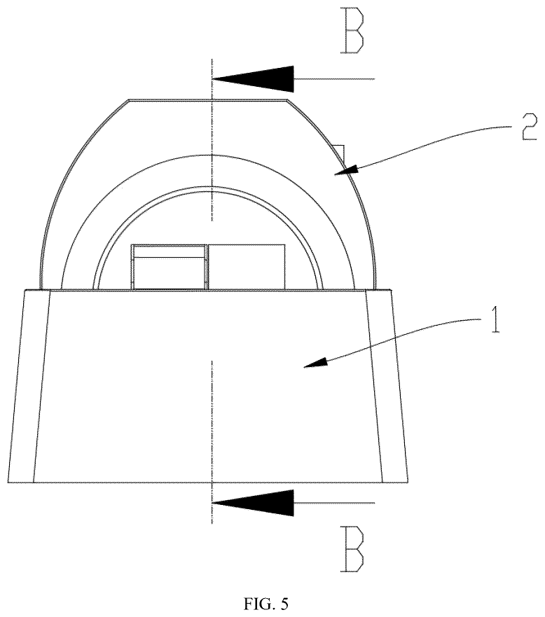

With reference to FIG. 1, FIG. 2 and FIG. 6, in one embodiment, the food inlet 200 is formed in the annular baffle 212. Preferably, the food inlet 200 is formed in the lowest position of the annular baffle 212 in the vertical direction. In this embodiment, the annular baffle 212 is fixed in the cavity, used for accommodating the pet foods, of the main food tank 1, and the lowest position of the annular baffle 212 in the vertical direction is located at the lowest position of the inner bottom surface of the main food tank 1. By means of this arrangement, when the pet foods are stored in the main food tank 1, the pet foods can slide to the lowest position of the inner bottom surfaces of the main food tank 1 by gravity and then enter the food storage member 21 on the periphery of the annular baffle 212 through the food inlet 200 at the lowest position of the annular baffle 212.

With reference to FIG. 2 to FIG. 3, preferably, the driving assembly 22 includes a motor 221 and a transmission gear set 222; clamping teeth 2113 are arranged on the peripheries of the side plates 2111, and the food storage member 21 is in meshed connection with the transmission gear set 222 through the clamping teeth 2113 on the side plates 2111; and the food storage member 21 can be driven by the driving assembly 22 to perform autorotation around the central axis of the food storage member 21. Exemplarily, the motor 221 and the transmission gear set 222 are fixedly connected to the fixed frame 25; and by adjusting the parameters of the motor 221, the autorotation speed of the food storage member 21 can be controlled by the transmission gear set 222.

With reference to FIG. 2 to FIG. 4, preferably, the driving assembly 22 further includes limiting members 223 fixedly connected to the fixed frame 25; the limiting members 223 are provided with limiting grooves 2230 which are slightly wider than the clamping teeth 2113; and the limiting grooves 2230 are arranged on the peripheries of the clamping teeth 2113 in a crossing mode. When the food storage member 21 is driven by the driving assembly 22 to perform autorotation, the clamping teeth 2113 will penetrate through the limiting grooves 2230 in sequence. The clamping teeth 2113 are limited by the limiting members 223, so that the autorotation of the food storage member 21 can be kept stable in the vertical direction, avoiding excessive deflection.

With reference to FIG. 2 to FIG. 4, preferably, at least two limiting members 223 are arranged, and a connecting line between the two limiting members 223 passes through the central axis of the food storage member 21, and is equally divided by the central axis. Optionally, two sets of limiting members 223 are arranged, and the connecting lines of the two sets of limiting members 223 are perpendicular to each other. By means of this arrangement, the stability of the autorotation of the food storage member 21 can be further guaranteed.

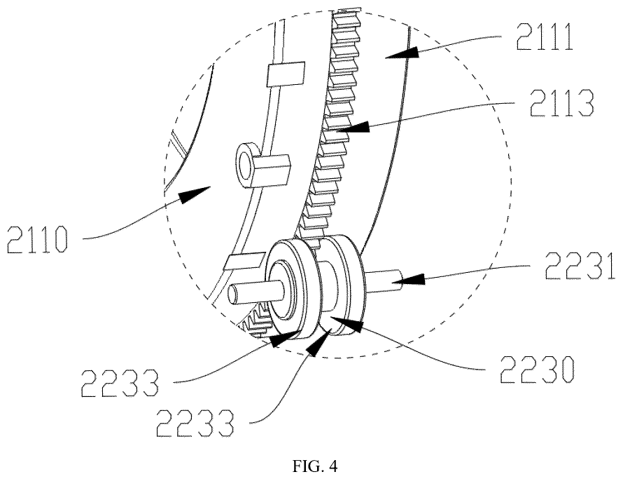

With reference to FIG. 4, preferably, each limiting member 223 includes a fixed shaft 2231 fixedly connected to the fixed frame 25, and a rolling guide wheel 2232 which sleeves the fixed shaft 2231; the rolling guide wheel 2232 is provided with two limiting wheels 2233 which are oppositely arranged and abut against the corresponding side plate 2111; and each limiting groove 2230 is formed between every two limiting wheels 2233.

Exemplarily, the rolling guide wheels 2232 are of an integrally-molded structure. When the food storage member 21 is subjected to autorotation, because the two limiting wheels 2233 abut against the side plates 2111, the guide wheels will be driven by the side plates 2111 to perform autorotation around the fixed shafts 2231; and by means of this arrangement, the autorotation of the food storage member 21 can be limited, and moreover, the friction force influence on the side plates 2111 can be reduced by the autorotation of the rolling guide wheels 2232, thereby preventing the autorotation efficiency of the food storage member 21 from being influenced.

With reference to FIG. 1 and FIG. 6, preferably, the pet feeder further includes food bowls 300 used for receiving the pet foods falling from the food outlet 400, and the food bowls 300 in the vertical direction are lower than the food outlet 400 and higher than the food inlet 200. Exemplarily, each food bowl 300 includes a conveying portion 301 arranged below the food outlet 400 and a bearing portion 302 arranged along the end, away from the food outlet 400, of the conveying portion 301; and the conveying portion 301 is arranged to be an inclined plane inclining from top to bottom so that the foods falling from the food outlet 400 can slide to the bearing portion 302 through the inclined plane.

Preferably, the food bowls 300 are arranged on the top of the main food tank 1. By means of this arrangement, space can be utilized to the maximum extent, and the space below the food bowl 300 can be fully utilized for food storage while a pet can take food at the higher position. In addition, the heavy main food tank 1 is arranged on the lower portion of the pet feeder, which is conducive to the placement stability of the whole pet feeder.

Preferably, the bottom of the cavity, used for accommodating the pet foods, of the main food tank 1 is arranged to be the inclined plane. By means of the inclined plane, the pet foods in the main food tank 1 can be gathered to the bottom of the inclined plane by gravity.

Preferably, the food inlet 200 in the vertical direction is lower than or slightly higher than the lowest position of the inclined plane of the main food tank 1, and by means of this arrangement, the foods in the main food tank 1 can be gathered to the bottom of the inclined plane and then enter the food storage member 21 through the food inlet 200 while the pet foods are stored to the maximum extent.

### Embodiment 2

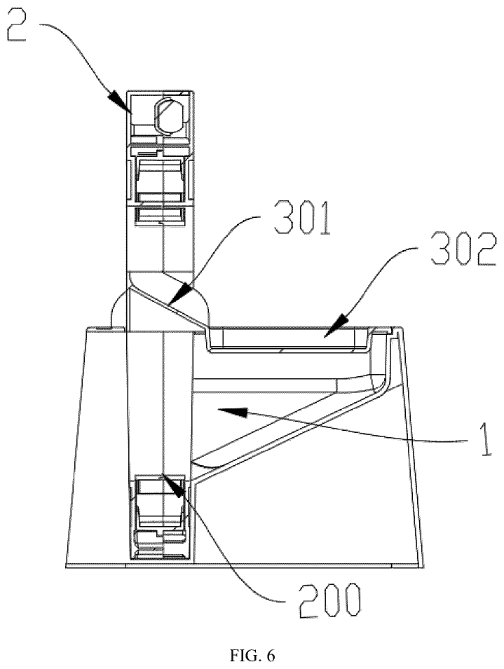

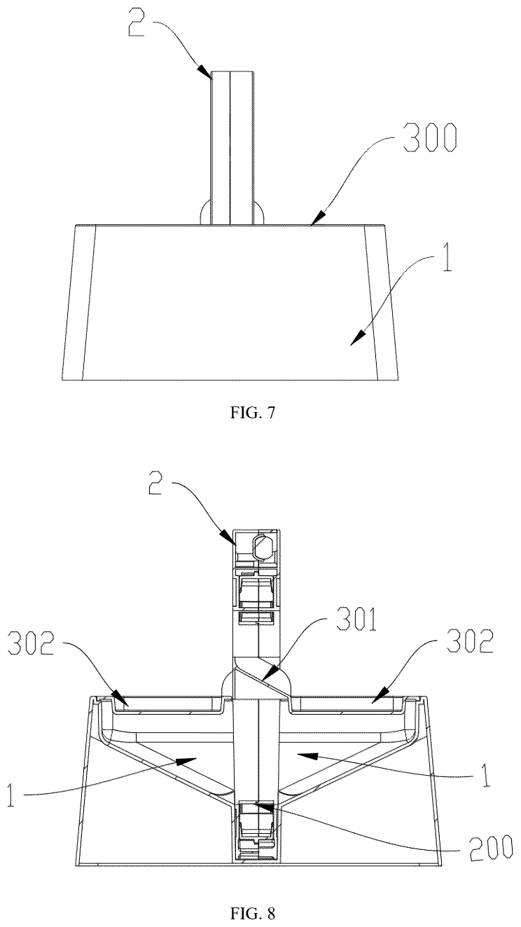

As shown in FIG. 7 to FIG. 8, which show an Embodiment 2 of a pet feeder provided by the present application; the Embodiment 2 involves all structures in the Embodiment 1; and moreover, the Embodiment 2 is different in that the food conveyer 2 is arranged on the central axis of the main food tank 1 and perpendicularly divides the main food tank 1 equally; and two food bowls 300 are arranged and located on two sides of the food conveyer 2 respectively.

Correspondingly, two food outlets 400 are formed, the openings of the two food outlets 400 are opposite in direction, and the two food outlets correspond to the two food bowls 300; furthermore, by controlling the autorotation direction and the autorotation angle of the food storage member 21, the food storage member 21 can rotate to the corresponding food outlet 400 in sequence, and then the pet feeder provided by this embodiment can be suitable for a scenario of feeding two pets. For example, the two food outlets 400 which are consistent in horizontal height and located on the two sides of a perpendicular bisector of the food storage member 21 respectively can be provided, the two food bowls 300 are arranged corresponding to the two food outlets 400 respectively, and therefore, the foods falling from the two food outlets 400 can fall into the bearing portions 302 of the two food bowls 300 by the conveying portions 301 of the two food bowls 300 respectively. Specifically, the driving assembly 22 drives the food storage member 21 to rotate clockwise to the food outlet 400 in the left side of the perpendicular bisector, and after the foods in the secondary food tanks 211 are fed through the food outlet 400 in the left side, the food storage member 21 is driven again to rotate anticlockwise to the food outlet 400 in the right side of the perpendicular bisector, and therefore, the effect that one feeder feeds foods into two independent food bowls 300 for two pets to eat can be achieved.

With reference to FIG. 7 to FIG. 8, in this embodiment, the main food tank 1 includes two storage cavities which are respectively arranged on two sides of the food conveyer 2, the inner bottom surfaces of the two storage cavities are both formed by inclining from the ends far away from the food conveyer 2 to the direction close to the food conveyer 2, funnel-shaped cavities are formed, and the bottom of the food conveyer 2 is located at the lowest positions of the funnel-shaped cavities. Furthermore, the food inlet 200 of the food storage member 21 is lower than the lowest position of the two storage cavities.

### Embodiment 3

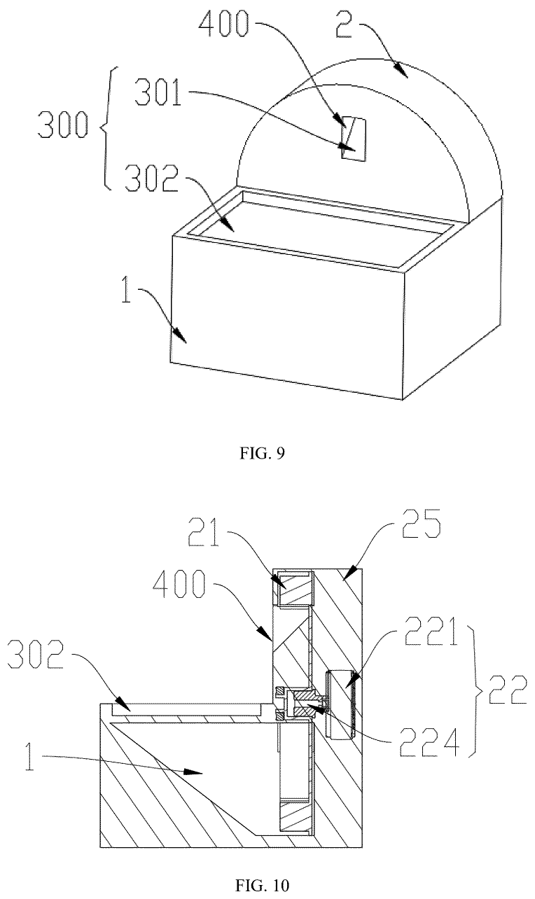

As shown in FIG. 9 to FIG. 11, which show an Embodiment 3 of a pet feeder provided by the present application; except the driving assembly 22 and the annular baffle 212, the rest structures in the Embodiment 3 are the same as the solution provided in the Embodiment 1; in the Embodiment 3, the driving assembly 22 includes the motor 221 and the transmission shaft 224, and the transmission shaft 224 is fixedly connected to the central axis of the food storage member 21; and when the motor 221 is started, the transmission shaft 224 will drive the food storage member 21 to perform autorotation around own central axis.

In other embodiments, the driving assembly 22 and the food storage member 21 can also be in transmission connection by a belt. The rotation of the food storage member 21 can be realized by a plurality of transmission modes, which is not limited to the type mentioned in the present application.

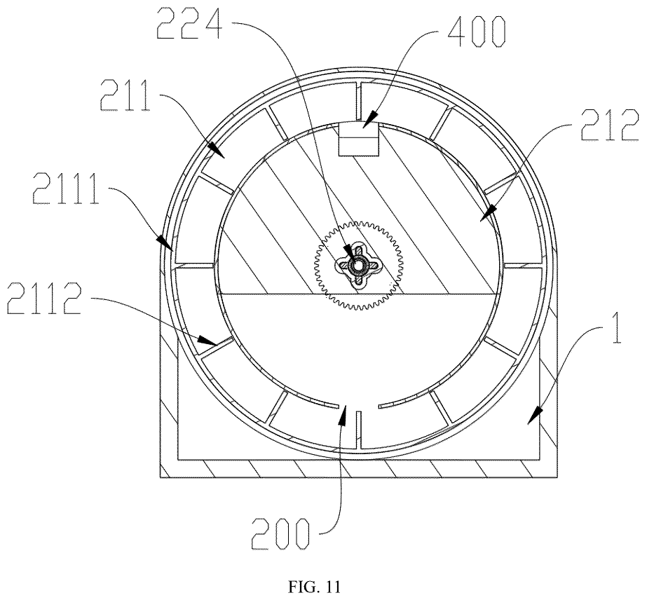

With reference to FIG. 11, the annular baffle 212 in the Embodiment 3 is set to be in an incomplete circular ring shape and is positioned at the upper half part of the inner edge of the food storage member 21, namely in this embodiment, the whole lower half part of the annular baffle 212 is the food inlet 200, and the foods in the main food tank 1 can freely pass through and fill the secondary food tanks 211 of the food storage member 21. In other embodiments, the annular baffle 212 can also be set to be in other circular ring shapes with notches, so that the foods can be fed.

### Embodiment 4

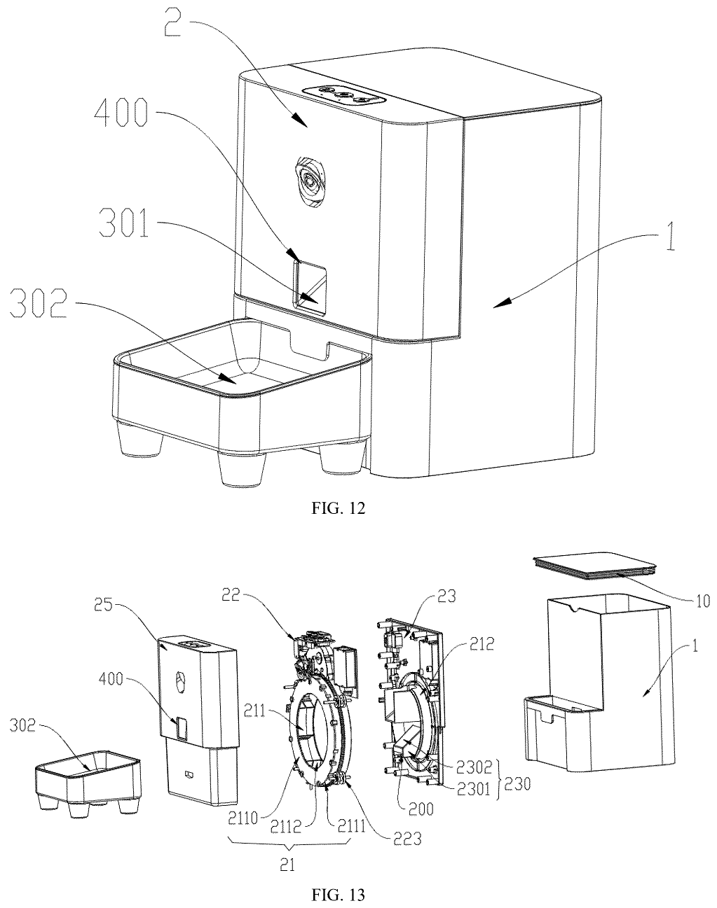

As shown in FIG. 12 to FIG. 14, which show an Embodiment 4 of a pet feeder provided by the present application; except the food bowls 300 and the main food tank 1, the rest structures in the Embodiment 4 are the same as the solution provided in the Embodiment 1; and in the Embodiment 4, the food bowls 300 and the main food tank 1 are arranged side by side, and the food conveyer 2 is used as a gap between the food bowls 300 and the main food tank 1. A main food tank cover 10 is arranged on the top of the main food tank 1 in a sealing manner.

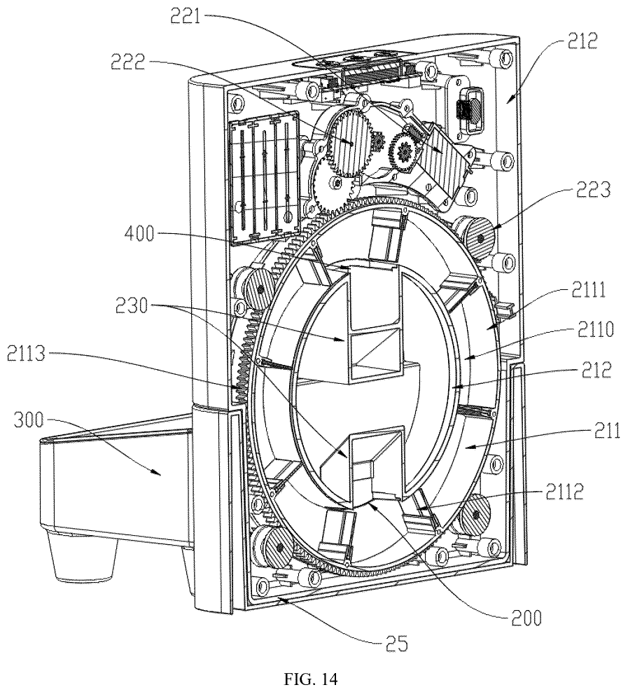

As shown in FIG. 13 and FIG. 14, in this embodiment, the food conveyer 2 further includes a food guide plate 23, and the food guide plate 23 is provided with food guide groove bodies 230 matched with the food inlet 200 and the food outlet 400 respectively. The food bowl 300 is arranged below the food guide groove body 230 matched with the food outlet 400.

The food guide groove body 230 arranged corresponding to the food inlet 200 can effectively guide the foods gathered at the food inlet 200 from an inner inclined plane of the main food tank 1, so that the efficiency of the foods entering the secondary food tanks 211 through the food inlet 200 is improved; and the food guide groove body 230 arranged corresponding to the food outlet 400 can effectively guide the pet foods falling from the openings of the secondary food tanks 211, so that the pet foods can smoothly fall into the food bowl 300 below.

Preferably, each food guide groove body 230 includes two guide portions 2301 which are arranged oppositely, and a sliding portion 2302 connected between the two guide portions 2301.

Preferably, the sliding portions 2302 are inclined planes, which is conducive to the foods falling into the food inlet 200 or the food outlet 400 along the inclined plane.

Finally, it is to be noted that the above provides a detailed explanation of the specific embodiments of the present application. The above-mentioned embodiments disclosed in the present application are only preferred embodiments of the present application. For those of ordinary skill in the art, many variations and improvements can be made without departing from the spirit of the present application. These variations and improvements are all within the scope of protection defined by the claims of the present application.

What is claimed is:

1. A pet feeder, comprising:
a main food tank provided with a cavity for accommodating pet foods; and
a food conveyer comprising a fixed frame fixedly connected to the main food tank, a food storage member for carrying the pet foods, and a driving assembly for driving the food storage member to move, the pet foods in the food storage member being carried from a lower position to a higher position by the driving assembly;
the food conveyer is provided with a food inlet communicating with the main food tank and a food outlet communicating with outside; the food storage member is provided with at least one opening; the pet foods in the main food tank enter the food storage member through the food inlet and the opening of the food storage member in sequence; and when the driving assembly drives the food storage member carrying the pet foods to move to the higher position, the pet foods in the food storage member fall to outside through the food outlet.

2. The pet feeder according to claim 1, wherein the food storage member comprises a plurality of secondary food tanks which are spaced from one another and are arranged in sequence; and by the driving of the driving component, any secondary food tank passes through the food inlet and the food outlet in sequence, and the secondary food tank communicates with the food inlet or the food outlet respectively when passing through the food inlet and the food outlet.

3. The pet feeder according to claim 2, wherein the food storage member is of a disc-shaped structure, and the plurality of secondary food tanks are arranged in a circumferential direction of the disc-shaped structure.

4. The pet feeder according to claim 3, wherein the food storage member comprises two oppositely-arranged annular panels, and side plates connected to outer edges of the two annular panels, and further comprises a plurality of partition plates which are simultaneously connected and fixed with the two annular panels and the side plates; and any two adjacent partition plates, the annular panels and the side plates are enclosed together to form the secondary food tanks.

5. The pet feeder according to claim 4, wherein the food conveyer further comprises an annular baffle which is embedded into an inner edge of the food storage member and is fixedly connected to the fixed frame; the food outlet is formed in the annular baffle; and the food outlet in a vertical direction is higher than the central axis of the annular baffle.

6. The pet feeder according to claim 5, wherein the food outlet is formed in the highest position of the annular baffle in the vertical direction.

7. The pet feeder according to claim 5, wherein the food inlet is formed in the annular baffle.

8. The pet feeder according to claim 5, wherein the driving assembly comprises a motor and a transmission gear set; clamping teeth are arranged on the peripheries of the side plates, and the food storage member is in meshed connection with the transmission gear set through the clamping teeth on the side plates; and
the food storage member can be driven by the driving assembly to perform autorotation around own central axis.

9. The pet feeder according to claim 8, wherein the driving assembly further comprises limiting members; the limiting members are provided with limiting grooves which are slightly wider than the clamping teeth; and the limiting grooves are arranged on the peripheries of the clamping teeth in a crossing mode.

10. The pet feeder according to claim 9, wherein at least two limiting members are arranged, and a connecting line between the two limiting members passes through the central axis of the food storage member.

11. The pet feeder according to claim 9, wherein each limiting member comprises a fixed shaft fixedly connected to the fixed frame, and a rolling guide wheel which sleeves the fixed shaft; the rolling guide wheel is provided with two limiting wheels which are oppositely arranged and abut against the corresponding side plate; and each limiting groove is formed between every two limiting wheels.

12. The pet feeder according to claim 1, further comprising food bowls used for receiving the pet foods falling from the food outlet, wherein the food bowls are lower than the food outlet and higher than the food inlet in the vertical direction.

13. The pet feeder according to claim 12, wherein food bowls are arranged on the top of the main food tank.

14. The pet feeder according to claim 13, wherein the food conveyer is arranged on the central axis of the main food tank and perpendicularly divides the main food tank equally; and two food bowls are provided and located on two sides of the food conveyer respectively.

15. The pet feeder according to claim 3, wherein the driving assembly comprises a motor and a transmission shaft, and the transmission shaft is fixedly connected to a central axis of the food storage member; and when the motor is started, the transmission shaft drives the food storage member to perform autorotation around own central axis.

16. The pet feeder according to claim 1, wherein the bottom of the cavity, used for accommodating the pet foods, of the main food tank is arranged to be an inclined plane.

17. The pet feeder according to claim 16, wherein the food inlet in the vertical direction is lower than the lowest position of the inner inclined plane of the main food tank.

18. The pet feeder according to claim 2, wherein the food conveyer further comprises a food guide plate, and the food guide plate is provided with food guide groove bodies matched with the food inlet and the food outlet respectively.

19. The pet feeder according to claim 18, wherein each food guide groove body comprises two guide portions which are arranged oppositely, and a sliding portion connected between the two guide portions.

20. The pet feeder according to claim 19, wherein the sliding portions are inclined planes.
